(19) United States
(12) Patent Application Publication
(10) Pub. No.: US 2024/0199476 A1
(43) Pub. Date: Jun. 20, 2024

(54) GLASS COMPOSITION RESISTANT TO ION BOMBARDMENT, CLADDING GLASS OF MICROCHANNEL PLATE, MICROCHANNEL PLATE AND PREPARING METHOD THEREOF

(71) Applicant: CHINA BUILDING MATERIALS ACADEMY, Beijing (CN)

(72) Inventors: Hua CAI, Beijing (CN); Hui LIU, Beijing (CN); Jinsheng JIA, Beijing (CN); Tiezhu BO, Beijing (CN); Yang ZHANG, Beijing (CN); Dongzhan ZHOU, Beijing (CN); Xiaoxuan SHI, Beijing (CN); Jiao LIAN, Beijing (CN); Chen WANG, Beijing (CN); Chang LIU, Beijing (CN)

(73) Assignee: CHINA BUILDING MATERIALS ACADEMY, Beijing (CN)

(21) Appl. No.: 17/420,924

(22) PCT Filed: Mar. 3, 2021
(86) PCT No.: PCT/CN2021/078834

§ 371 Date: Aug. 11, 2023

(51) Int. Cl. C03C 13/00; C03B 5/18; C03B 5/225; C03B 25/02; C03B 37/012; C03B 37/028; C03C 3/102; C03C 3/105; C03C 4/20; C03C 15/00; C03C 17/09; H01J 43/18

(52) U.S. Cl. CPC C03C 13/005; C03B 5/18; C03B 5/225; C03B 25/02; C03B 37/01214; C03B 37/028; C03C 3/102; C03C 3/105; C03C 4/20; C03C 15/00; C03C 17/09; H01J 43/18; C03C 2204/00; C03C 2213/00; C03C 2218/151

(57) ABSTRACT

The present invention relates to the field of special glass materials and preparation, in particular to a glass composition resistant to ion bombardment, a cladding glass of microchannel plate, a microchannel plate and a preparing method thereof. The coordination between the components and the adjustment of the dosage, in particular, oxides with high bond energy containing scandium and/or strontium and/or zirconium and/or molybdenum, can be introduced into the glass material, so as to improve the surface binding energy (SBE), thereby improving the ion bombardment resistance of the glass material and significantly prolonging the working life of the microchannel plate during detecting high-energy ions directly, while meeting other necessary properties such as good anti-crystallization, good acid and alkali resistance, appropriate softening temperature, thermal expansion coefficient, and bulk resistance, etc.

### TECHNICAL FIELD

The present invention relates to the field of special glass materials and preparation, in particular to glass composition resistant to ion bombardment, cladding glass of microchannel plate, microchannel plate and preparing method thereof.

### BACKGROUND

The microchannel plate is a special glass material and device that allows paralleled multiplication of charged particles distributed in two-dimensional space, and has become an important device with the most potential for high-energy ion detection, due to the advantages such as high time resolution, high spatial resolution, extremely high signal amplification, compact structure, and low noise. The microchannel plate is composed of millions of paralleled 1 glass capillaries with micron-level channel. There is a secondary electron emission layer and an electron conduction layer on the wall of each independent paralleled glass microchannel, which can independently carry out secondary electron emission and weak current amplification. The input signal particles for the microchannel plate are usually electrons, and during signal amplification, the electrons usually directly bombard the microchannel plate. However, collision and sputtering effects will occur when high-energy ions directly bombard the microchannel plate to generate electron multiplication, that is because the mass of the ions is thousands or tens of thousands of times that of electrons, under the same electric field, the ion bombardment has a higher momentum and larger relative impulse. For the same reason, it is more likely to cause degradation and failure of the performance of the microchannel plate, which affects the service life of the device.

The basic principle of signal amplification for the microchannel plate is that under the action of the accelerating electric field, the incident charged particles bombard the inner wall surface of the channel to generate secondary emission electrons. The electrons collide with the wall of microchannel multiple times, and produce one or more secondary electrons in the microchannel to achieve electron avalanche, thereby realizing the reading and detection of weak signals. When the incident charged particles are ions, due to the large ion mass and high bombardment energy, the ions will inevitably interact with the material of the microchannel plate, leading to collision and sputtering effects. During the continuous collision from the ions, the atoms on the surface of the microchannel plate will constantly overcome the surface binding energy with a certain probability and break away from the material surface, which will cause damage to the surface of the material and degradation of device performance. Therefore, poor ion bombardment resistance has become the main bottleneck for the detection of high-energy ions in the microchannel plate.

Currently, the existing literature shows that material damage caused by ion bombardment is one of the main reasons for the failure of the multiplier for low-energy/high-energy ion detection. It has been mentioned in related patents that in the design and manufacture of devices that may be directly bombarded by ions, such as field effect transistors, plasma displays, and cold cathodes of electron emission devices, the service life of the devices is improved by use of corresponding ion bombardment-resistant materials. However, regarding the microchannel plate for ion detection, there is no public report in related patents or documents that the ion bombardment resistance of the microchannel plate can be improved by the design and optimization of the glass material constitution of the microchannel plate.

### SUMMARY

Therefore, the technical problem to be solved by the present invention is to overcome the disadvantages of the poor ion bombardment resistance of microchannel plate glass materials in the prior art, thereby providing a glass composition resistant to ion resistance, a cladding glass of microchannel plate, a microchannel plate and a preparing method thereof.

To this end, the present invention provides the following technical solutions:

The present invention provides a glass composition resistant to ion bombardment, in terms of mole percentage, comprising:
60 mole % to 78 mole % of SiO₂;
1 mole % to 6 mole % of Bi₂O₃;
5 mole % to 18 mole % of PbO;
5 mole % to 20 mole % of alkali metal oxide;
2 mole % to 8 mole % of alkaline-earth metal oxide;
0.1 mole % to 2.5 mole % of Al₂O₃; and
3 mole % to 9 mole % of specialty oxide;
wherein, the specialty oxide is selected from at least one of Sc₂O₃, SrO, ZrO₂, MoO₃ and MoO₂, and
0 mole % to 9 mole % of Sc₂O₃;
0 mole % to 9 mole % of SrO;
0 mole % to 6 mole % of ZrO₂; and
0 mole % to 3 mole % of MoO₃ and/or MoO₂.

Optionally, based on the total mass of the components mentioned above, the glass composition further comprises a clarifying agent accounting for 0.1% to 0.8% of the total mass of the components.

Optionally, the alkali metal oxide is selected from at least one of Na₂O, K₂O and Cs₂O.
the alkaline-earth metal oxide is selected from at least one of MgO, BaO and CaO;
the clarifying agent is Sb₂O₃ and/or As₂O₃.

It should be noted that there is no specific requirements on the composition of the alkali metal oxides and alkaline-earth metal oxides, as long as the amount of them can meet the requirements of the present invention.

The present invention provides a cladding glass of microchannel plate resistant to ion bombardment, and the composition of the cladding glass of microchannel plate is the same as that of the glass composition mentioned above.

The present invention also provides a method for preparing the cladding glass of microchannel plate resistant to ion bombardment, comprising the following steps:
proportioning components, and mixing uniformly, followed by melting, clarifying, homogenizing, drawing and forming, and annealing to obtain the cladding glass of microchannel plate resistant to ion bombardment.

Optionally, the temperature in the melting step is from 1250° C. to 1550° C.

In the melting step, materials mixed uniformly can be added to a crucible in one or more times for melting according to the total weight of the materials, and when added to the crucible in a plurality of times, the interval between each addition is 10 minutes to 90 minutes.

Optionally, the melting is performed under a weak oxidizing atmosphere, and an oxygen partial pressure in the weak oxidizing atmosphere is from 25 kPa to 100 kPa.

In the clarifying step, the temperature is from 1400° C. to 1600° C., and the time is from 2 hours to 12 hours.

In the homogenizing step, the temperature is from 1200° C. to 1500° C., and the time is from 1 hour to 5 hours.

The initial temperature of the drawing into shape is 1000˜1350° C., until the temperature is lowered to below 600° C.˜750° C. to form a glass tube material.

In the annealing step, the holding temperature is from 550° C. to 750° C., the holding time is from 2 hours to 12 hours, and then the temperature is lowered to room temperature as furnace cooling.

The present invention provides a microchannel plate resistant to ion bombardment, comprising,
a substrate; and an electrode arranged on the upper and lower surface of the substrate; wherein the substrate comprises a cladding glass with independent paralleled microchannels and a solid-border glass coated on the outer surface of the cladding glass, the cladding glass is the cladding glass of microchannel plate mentioned above or the cladding glass of microchannel plate prepared by the method mentioned above.

The present invention also provides a method for preparing a microchannel plate resistant to ion bombardment, comprising the following steps:
S1. drawing and forming a cladding glass tube;
S2. preparing a core material glass rod;
S3. nesting the core material glass rod into the cladding glass tube and drawing into a single-fiber;
S4. packing several single-fibers for drawing into a multi-fiber;
S5. stacking the multi-fibers regularly, and fusing into a boule;
S6. slicing, chamfering, grounding and polishing the boule to obtain a wafer;
S7. etching the wafer by chemical etchant to remove a core glass, followed by hydrogen reduction and vacuum deposition of metal electrodes, thus obtaining the microchannel plate resistant to ion bombardment.

Optionally, the step S7 specifically comprises: corroding the wafer by chemical etchant to remove a core glass to prepare independent paralleled microchannels structure with millions of micron-level pores; reducing the independent paralleled microchannels structure by high-temperature hydrogen to form a conductive layer resistant to ion bombardment and a secondary electron emission layer resistant to ion bombardment growing in situ on the inner wall surface of the independent paralleled microchannels; and then, vapor-depositing metal electrodes on the upper and lower surfaces of a reduced plate to obtain the microchannel plate resistant to ion bombardment.

Optionally, in step S1, the temperature for drawing and forming the cladding glass tube is from 1000° C. to 1350° C.

In step S7, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.

In step S7, the temperature for the high-temperature hydrogen reduction is from 350° C. to 550° C., the time for the high-temperature hydrogen reduction is from 20 mins to 600 mins, and the flow rate of the hydrogen is from 0.005 L/min to 10 L/min.

In step S7, the metal electrode is Ti, or Cr, or Au, or Ag, or Ni/Cr surface electrode; the sheet resistance of the metal electrode is not higher than 300Ω.

The glass composition resistant to ion bombardment provided by the present invention can be adjusted and controlled by means of the composition of the glass material, into which the specialty oxide can be introduced directly. Oxides with high bond energy containing scandium and/or strontium and/or zirconium and/or molybdenum can be introduced into the glass material for microchannel plates with SiO₂ as the glass network former and Bi₂O₃ and/or PbO as the reactive oxides that can form the conductive metal phase, in order to adjust the composition of glass materials and improve the surface binding energy, and the sputtering threshold of glass materials, thereby achieving a great improvement in the ion bombardment resistance of the glass material, meanwhile meeting other necessary properties such as good anti-crystallization performance, good chemical resistance, appropriate softening temperature, thermal expansion coefficient, and bulk resistance, etc. Further, the glass material is prepared into a microchannel plate resistant to ion bombardment, so as to greatly improve the working life of the microchannel plate against ion bombardment.

SiO₂, an oxide of glass former, is the interconnected backbone of the glass network and the main component of the cladding glass. When the content exceeds 78 mol % in the glass, there is a large amount of [SiO₂] plane structure, which is not conducive to the chemical stability of the glass and also reduces the viscosity of the glass, increases the thermal expansion coefficient, and deteriorates compatibility with the core glass of microchannel plate resistance to ion bombardment.

Bi₂O₃ is glass network modifier and the fluxing agent of glass. Adding proper amount of Bi₂O₃ to glass can improve the material properties of glass forming, improve the thermal processing performance of glass, and reduce the high temperature melting viscosity of glass, and the conductive metal phase in the conductive layer can be formed after high temperature hydrogen reduction. When the content of Bi₂O₃ exceeds 6 mol %, phase separation is easy to occur, and the resistance performance of the glass is unstable after reduction. When the content of Bi₂O₃ is less than 1 mol %, the bulk resistance of the manufactured microchannel plate is unstable.

PbO is a glass network modifier and the good fluxing agent of glass. Adding proper amount of PbO to glass can improve the material properties of glass forming, improve the thermal processing performance of glass, and reduce the high temperature melting viscosity of glass, and the conductive metal phase in the conductive layer can be formed after high temperature hydrogen reduction. When the content of PbO exceeds 18 mol %, the ion bombardment resistance of the glass will deteriorate, and the resistance stability of the glass after reduction will become poor. When the content of PbO is less than 5 mol %, the bulk resistance of the manufactured microchannel plate is higher and unstable.

Na₂O, K₂O and Cs₂O are the glass network modifier. Alkali metal ions are easy to migrate and diffuse in the glass and can reduce the viscosity of glass during high-temperature melting and make the glass easy to melt, so they are good fluxing agent and also increase thermal expansion coefficient, but reduce the chemical stability and mechanical strength of the glass, reduce the ion bombardment resistance of the glass, therefore the amount of Na₂O, K₂O and Cs₂O introduced into the glass should not be excessive; and the introduced amount can be adjusted according to the content of the matching Na₂O, K₂O and Cs₂O in the core glass of the microchannel plate resistant to ion bombardment, by introducing one or more of Na₂O, K₂O and Cs₂O into the glass, the diffusion of core-clad can be reduced during fiber drawing and high-temperature hot pressing. If the total content of Na₂O, K₂O and Cs₂O is less than 5%, the glass-forming properties are poor, but if the total content of Na₂O, K₂O and Cs₂O is greater than 20 mol %, the thermal expansion is too high, the glass stability is poor, and the glass has poor ion bombardment resistance.

MgO, BaO and CaO are the glass network modifier, and alkaline-earth metal oxides, which are beneficial to improve the anti-crystallization ability of the glass, adjust the material properties of the glass, and improve the thermal processing performance of the glass. But overusing will result in unstable glass performance and generate phase separation. If the total content of MgO, BaO, and CaO is less than 2 mol %, the thermal processing performance of the glass will be poor, but if the total content is greater than 8 mol %, phase separation of the glass will easily occur.

Al₂O₃ is an oxide that adjusts the glass structure, and its content affects the thermal expansion coefficient and chemical and thermal stability of the glass. However, when its content exceeds 2.5 mol %, it will increase the refractive index and dispersion of the glass, reduce the conductivity of the glass, which is not conducive to the ion bombardment resistance of the glass. When it is less than 0.1 mol %, the thermal stability of the glass will be poor.

Sc₂O₃ is a glass intermediate oxide and used for regulating the ion bombardment resistance of glass. It can increase the hardness, ion bombardment resistance and softening temperature of the glass, and reduce the thermal expansion coefficient of the glass. When its content exceeds 9 mol %, crystallization will occur, glass stability becomes poor, and the glass transition temperature and softening temperature are too high, which is not conducive to the subsequent preparation for glass microchannel plate resistant to ion bombardment.

SrO is an oxide that regulates the ion bombardment resistance of glass. It can increase the hardness and ion bombardment resistance, and reduce the high temperature viscosity of glass. When its content exceeds 9 mol %, crystallization will occur, glass stability becomes poor, and the thermal expansion coefficient of glass is too large, which is not conducive to the subsequent preparation for glass microchannel plate resistant to ion bombardment.

ZrO₂ is a glass intermediate oxide, which can increase glass viscosity, hardness, chemical stability, and reduce glass thermal expansion coefficient. When its content exceeds 6 mol %, the glass forming range is narrow and the softening temperature is too high, which is not conducive to the thermoforming and processing of glass resistant to ion bombardment, and is prone to crystallization and phase separation, and the glass performance is unstable.

MoO₃ and MoO₂ are oxides that regulate the ion bombardment resistance of glass, which can improve the hardness and ion bombardment resistance of glass. However, when their content exceeds 3 mol %, crystallization and phase separation will occur, and the glass stability will deteriorate.

When the total content of Sc₂O₃, SrO, ZrO₂, MoO₃, and MoO₂ is less than 3 mol %, the ion bombardment resistance of the glass is insufficient; but when their total content exceeds 9 mol %, crystallization and phase separation will occur, and the stability of the glass will deteriorate.

Preferably, for the aforementioned cladding glass of microchannel plate resistant to ion bombardment, wherein, the transition temperature is T_{g}≥545° C., and the softening temperature is T_{f}≥627° C.

Preferably, for the aforementioned cladding glass of microchannel plate resistant to ion bombardment, wherein, the thermal expansion coefficient between 20° C. and 300° C. is (61˜95)×10⁻⁷/° C.

Preferably, for the aforementioned cladding glass of microchannel plate resistant to ion bombardment, wherein, there is no crystallization between 530° C. and 950° C., and has good crystallization resistance.

Optionally, the glass composition resistant to ion bombardment, in terms of mole percentage, comprises:
60 mole % to 78 mole % of silica sand;
1.0 mole % to 6.0 mole % of bismuth oxide;
5.0 mole % to 18 mole % of lead oxide;
5.0 mole % to 20 mole % of substance selected from at least one of sodium carbonate, potassium salt and cesium carbonate;
2.0 mole % to 8.0 mole % of substance selected from at least one of basic magnesium carbonate, barium salt and calcium carbonate;
0.1 mole % to 2.5 mole % of aluminum hydroxide; and
3.0 mole % to 9.0 mole % of substance selected from at least one of scandium salt, strontium salt, zirconium compound, and molybdenum compound;
wherein,
0 mole % to 9 mole % of scandium nitrate and/or scandium carbonate;
0 mole % to 9 mole % of strontium carbonate and/or strontium nitrate;
0 mole % to 6 mole % of zirconium oxide or zirconium carbonate or zirconium nitrate; and
0 mole % to 3 mole % of molybdic acid or molybdenum trioxide or molybdenum dioxide.

Wherein, the lead oxide is red lead or yellow lead; the barium salt is barium nitrate or barium carbonate; the potassium salt is potassium carbonate or potassium nitrate; the scandium salt is scandium nitrate or scandium carbonate; the strontium salt is strontium carbonate or strontium nitrate; the zirconium compound is zirconium oxide or zirconium carbonate or zirconium nitrate; the molybdenum compound is molybdic acid or molybdenum trioxide or molybdenum dioxide; the clarifying agent is Sb₂O₃ and/or As₂O₃.

The technical solution of the present invention has the following advantages:
1. The glass composition resistant to ion bombardment provided by the present invention can be adjusted and controlled by means of the composition of the glass material, into which the specialty oxide can be introduced directly to achieve the adjustment and control for the composition of the glass material and increase the sputtering threshold of glass material, thereby improving the ion bombardment resistance and the working life of glass materials, and promoting the further application of glass materials in the fields of time-of-flight mass spectrometers, ultra-precision timing instruments (ie. atomic clocks), and high-energy ion detection. Specifically, oxides with high single bond energy containing scandium and/or strontium and/or zirconium and/or molybdenum can be introduced into the glass material through the coordination between the components and the adjustment of the dosage, so as to improve the surface binding energy, thereby improving the ion bombardment resistance of the glass material and significantly prolonging the working life of the microchannel plate during detecting high-energy ions directly, while meeting other necessary properties such as good anti-crystallization performance, good chemical resistance, appropriate softening temperature, expansion coefficient, and bulk resistance, etc.
2. The microchannel plate resistant to ion bombardment provided by the present invention can be adjusted and controlled by means of the composition of the microchannel plate glass material, into which the specialty oxide can be introduced directly to achieve the adjustment and control for the composition of the glass material and increase the sputtering threshold of microchannel plate glass material, thereby improving the ion bombardment resistance and significantly prolonging the working life of the microchannel plate, and promoting the further application of the microchannel plate in the fields of time-of-flight mass spectrometers, precision timing instruments, and high-energy ion detection.

### DESCRIPTION OF THE DRAWINGS

In order to more clearly describe the specific embodiments of the present invention or the technical solutions in the prior art, the drawings that need to be used in the specific embodiments or the description of the prior art will be introduced briefly in the following. Obviously, the drawings in the following description represent some embodiments of the present invention. For those skilled in the art, other drawings can be obtained based on these drawings without creative work.

FIG. 1 shows a comparison diagram of ion etching rate of the cladding glass of microchannel plate provided by the embodiment of the present invention and the comparative example;

FIG. 2 shows a comparison curve of total extracted charge (working life) when the microchannel plate provided by the embodiment of the present invention and the comparative example is bombarded under 5 keV argon ion and 2.5 keV cesium ion;

FIG. 3 is a schematic diagram of the structure of the wafer of microchannel plate resistant to ion bombardment according to the present invention;

FIG. 4 is a schematic diagram of the structure of the capillary plate of microchannel plate resistant to ion bombardment according to the present invention;

FIG. 5 is a schematic diagram of the structure of microchannel plate resistant to ion bombardment according to the present invention.

### EXPLANATION OF THE MEANING OF EACH SIGN IN THE DRAWINGS

1—ion etching rate when 5 keV argon ions bombard different glasses;
2—ion etching rate when 2.5 keV cesium ions bombard different glasses;
Quartz—quartz glass (glass of comparative Example 3);
C1—glass of Comparative Example 1;
C2—glass of Comparative Example 2;
C3—glass of Example 1;
C4—glass of Example 7;
C5—glass of Example 11;
C6—glass of Example 16;
C7—glass of Example 21;
3—curve of total extracted charge when the microchannel plate resistant to ion bombardment is bombarded under 5 keV argon ions;
4—curve of total extracted charge when the glass of Comparative Example 1 is bombarded under 5 keV argon ions;
5—curve of total extracted charge when the microchannel plate resistant to ion bombardment is bombarded under 2.5 keV cesium ions;
6—curve of total extracted charge when the glass of Comparative Example 1 is bombarded under 2.5 keV cesium ions;
7—cladding glass;
8—core glass;
9—solid-border glass;
10—microchannel plate substrate;
11—inner wall of the channel of microchannel plate;
12—electrode;
13—emission layer and conductive layer resistant to ion bombardment generated in situ.

### EMBODIMENTS

The following examples are provided for a better understanding of the present invention, and are not limited to the best embodiment, and do not constitute a limition for the content and protection scope of the present invention. Any product identical or similar to that of the present invention, obtained by anyone combining the present invention with the features of other prior art or obtained by anyone under the teaching of the present invention, falls within the protection scope of the present invention.

If the specific experimental steps or conditions are not indicated in the examples, it can be carried out according to the conventional experimental steps or conditions described in the documents in the field. The reagents or instruments used without the manufacturer's indication are all conventional reagent products that are commercially available.

### Example I (1˜5)

This example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:
(1) A cladding glass tube is prepared as follows

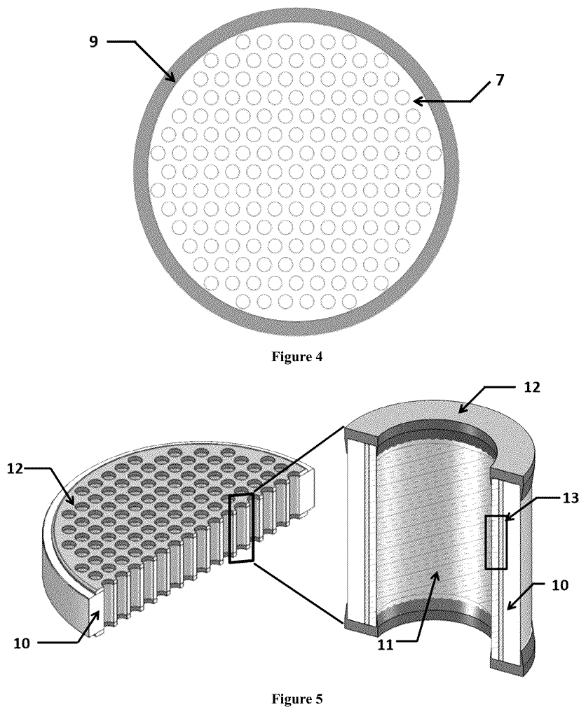

Table 1 shows the composition of glass material for a cladding glass tube to be prepared by the following steps:
1) quartz sand, red lead, bismuth oxide, barium carbonate, sodium carbonate, cesium carbonate, potassium nitrate, basic magnesium carbonate, calcium carbonate, aluminum hydroxide, and scandium salt are mixed, and clarifying agent Sb₂O₃ is added to form a glass batch;
more specifically, in Example I, sodium carbonate:cesium carbonate:potassium nitrate=1:2:1, barium carbonate:basic magnesium carbonate:calcium carbonate=120:100:1, and the scandium salt in Examples 1 to 5 is scandium nitrate and/or scandium carbonate, in Example 1, the scandium salt is scandium nitrate; in Example 2, the scandium salt is scandium carbonate; in Example 3, the scandium salt is a mixture of scandium nitrate and scandium carbonate (scandium nitrate:scandium carbonate=1:1); in Example 4, the scandium salt is a mixture of scandium nitrate and scandium carbonate (scandium nitrate:scandium carbonate=3:1); in Example 5, the scandium salt is a mixture of scandium nitrate and scandium carbonate (scandium nitrate:scandium carbonate=1:2).
2) the glass batch containing the clarifying agent evenly mixed is put into a crucible for melting at 1250° C.˜1490° C.;
3) after the melting is completed, the temperature is raised to 1550±50° C. for clarification for 2.5 hours;
4) then the temperature is reduced to 1440±40° C.˜1480° C. for 2 hours for homogenization to form molten glass;
5) the molten glass is drawn from 1150±150° C. until the temperature is lowered to below 650° C. to form a glass tube material;
6) annealing treatment for the formed glass tube material is carried out by holding the temperature at 600±50° C. for 12 hours, and then cooling down to room temperature as furnace cooling to form cladding glass tube.
(2) the cladding glass tube resistant to ion bombardment is nested with microchannel plate core glass rod, followed by drawing and forming glass single-fibers and glass multi-fibers, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.; more specifically, in this example, the chemical etchant is the mixture of nitric acid and hydrochloric acid (nitric acid:hydrochloric acid=1:1), the total concentration of the chemical etchant is 15 mol %, the etching time of the chemical etchant is 150 minutes, the etching temperature of the chemical etchant is 70° C.±5° C., FIG. 4 shows the structure of the capillary plate of microchannel plate comprising a cladding glass 7 and a solid-border glass 9.
(4) Subsequently, the capillary plate of microchannel plate is reduced by hydrogen under high temperature and plated with metal electrodes successively to obtain the microchannel plate resistant to ion bombardment. Wherein the temperature for high-temperature hydrogen reduction is from 350° C. to 550° C., the time for the high-temperature hydrogen reduction is from 20 mins to 600 mins, and the flow rate of the hydrogen is from 0.005 L/min to 10 L/min; an emission layer and conductive layer resistant to ion bombardment is generated in situ. More specifically, in this embodiment, the preferred temperature for high-temperature hydrogen reduction is 550° C., the reduction time is 240 min, and the flow rate of hydrogen is 0.5 L/min; the metal electrode is preferably a surface electrode deposited Ni—Cr by electron beam evaporation; the sheet resistance of the metal electrode is not higher than 300Ω. The microchannel plate with solid border resistant to ion bombardment has a channel diameter of 4-20 μm and a thickness of 0.20˜0.80 mm, and an overall diameter Φ=10 mm˜60 mm. More specifically, the microchannel plate with solid border resistant to ion bombardment has a channel diameter of 8 μm and a thickness of 0.32±0.02 mm, and an overall diameter Φ=25 mm. FIG. 5 shows the structure of the above mentioned microchannel plate resistant to ion bombardment comprising microchannel plate substrate 10, inner wall of the channel of microchannel plate 11, electrode 12, wherein, the inner wall of the channel of microchannel plate comprises emission layer and conductive layer resistant to ion bombardment generated in situ 13.

### Example II (6˜10)

This example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:

### (1) A Cladding Glass Tube is Prepared as Follows

Table 1 shows the composition of glass material for a cladding glass tube to be prepared by the following steps:
1) quartz sand, yellow lead, bismuth oxide, barium nitrate, sodium carbonate, cesium carbonate, potassium carbonate, basic magnesium carbonate, calcium carbonate, aluminum hydroxide, and strontium salt are mixed, and clarifying agent As₂O₃ is added to form a batch;
more specifically, in Example II, sodium carbonate:cesium carbonate:potassium carbonate=11:53:13, barium nitrate:basic magnesium carbonate:calcium carbonate=50:3:2, and the strontium salt in Examples 6 to 10 is strontium nitrate and/or strontium carbonate, in Example 6, the strontium salt is strontium nitrate; in Example 7, the strontium salt is strontium carbonate; in Example 8, the strontium salt is a mixture of strontium nitrate and strontium carbonate (strontium nitrate:strontium carbonate=1:2); in Example 9, the strontium salt is a mixture of strontium nitrate and strontium carbonate (strontium nitrate:strontium carbonate=3:1); in Example 10, the strontium salt is a mixture of strontium nitrate and strontium carbonate (strontium nitrate:strontium carbonate=3:2).
2) the batch containing the clarifying agent evenly mixed is put into a crucible for melting at 1250° C.˜1550° C.;
3) after the melting is completed, the temperature is raised to 1575±25° C. for clarification for 12 hours;
4) after the clarification, the temperature is reduced to 1525±25° C. for 1 hour for homogenization to form molten glass;
5) the molten glass is drawn from 1200±100° C. until the temperature is lowered to below 700° C. to form a glass tube material;
6) anneal treatment for the formed glass tube material is carried out by holding the temperature at 650±50° C. for 2 hours, and then cooling down to room temperature as furnace cooling to form cladding glass tube.
(2) the glass tube is nested with microchannel plate core glass rod resistant to ion bombardment, followed by drawing and forming glass single-fiber and glass multi-fiber, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.; more specifically, in this example, the chemical etchant is nitric acid, the total concentration of the chemical etchant is 5 mol %, the etching time of the chemical etchant is 100 minutes, the etching temperature of the chemical etchant is 65° C.±5° C., FIG. 4 shows the structure of the capillary plate of microchannel plate comprising a cladding glass 7 and a solid-border glass 9.
(4) Subsequently, the capillary plate of microchannel plate is reduced by hydrogen under high temperature and plated with metal electrodes successively to obtain the microchannel plate resistant to ion bombardment. Wherein the temperature for high-temperature hydrogen reduction is from 350° C. to 550° C., the time for the high-temperature hydrogen reduction is from 20 mins to 600 mins, and the flow rate of the hydrogen is from 0.005 L/min to 10 L/min; an emission layer and conductive layer resistant to ion bombardment is generated in situ. More specifically, in this embodiment, the preferred temperature for high-temperature hydrogen reduction is 520° C., the reduction time is 300 min, and the flow rate of hydrogen is 0.3 L/min; the metal electrode is preferably an surface electrode deposited Au by electron beam evaporation; the sheet resistance of the metal electrode is not higher than 300Ω. The microchannel plate with solid border resistant to ion bombardment has a channel diameter of 4-20 μm and a thickness of 0.20˜0.80 mm, and an overall diameter Φ=10 mm˜60 mm. More specifically, the microchannel plate with solid border resistant to ion bombardment has a channel diameter of 10 μm and a thickness of 0.40±0.02 mm, and an overall diameter Φ=25 mm. FIG. 5 shows the structure of the above mentioned microchannel plate resistant to ion bombardment comprising microchannel plate substrate 10, inner wall of the channel of microchannel plate 11, electrode 12, wherein, the inner wall of the channel of microchannel plate comprises emission layer and conductive layer resistant to ion bombardment generated in situ 13.

### Example III (11˜15)

This example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:

### (1) A Cladding Glass Tube is Prepared as Follows

Table 1 shows the composition of glass material for a cladding glass tube to be prepared by the following steps:
1) quartz sand, red lead, yellow lead, bismuth oxide, barium nitrate, barium carbonate, sodium carbonate, cesium carbonate, potassium carbonate, potassium nitrate, basic magnesium carbonate, calcium carbonate, aluminum hydroxide, and zirconium compounds are mixed, and clarifying agent As₂O₃ and Sb₂O₃ are added to form a batch;
wherein, red lead:yellow lead=1:1, barium nitrate:barium carbonate=1:2, potassium carbonate:potassium nitrate=2:3, As₂O₃:Sb₂O₃=1:2;
more specifically, in Example III, sodium carbonate:cesium carbonate:(potassium carbonate+potassium nitrate)=7:5:1, (barium nitrate+barium carbonate):basic magnesium carbonate:calcium carbonate=1:10:3, zirconium compound in Examples 11-15 is zirconium oxide and/or zirconium nitrate and/or zirconium carbonate. In Example 11, the zirconium compound is zirconium oxide; in Example 12, the zirconium compound is the mixture of zirconium oxide and zirconium nitrate (zirconium oxide:zirconium nitrate=1:1); in Example 13, the zirconium compound is the mixture of zirconium oxide and zirconium carbonate (zirconium oxide:zirconium carbonate=1:1); in Example 14, the compound of zirconium is the mixture of zirconium oxide, zirconium nitrate and zirconium carbonate (zirconium oxide:zirconium nitrate:zirconium carbonate=1:1:1); in Example 15, the compound of zirconium is the mixture of zirconium oxide, zirconium nitrate and zirconium carbonate (zirconium oxide:zirconium nitrate:zirconium carbonate=2:1:3);
2) the batch containing the clarifying agent evenly mixed is put into a crucible for melting at 1250° C.˜1550° C.;
3) after the melting is completed, the temperature is raised to 1575±25° C. for clarification for 10 hours;
4) then the temperature is reduced to 1475±25° C. for 4.5 hours for homogenization to form molten glass;
5) the molten glass is drawn from 1225±125° C. until the temperature is lowered to below 730° C. to form a glass tube material;
6) anneal treatment for the formed glass tube material is carried out by holding the temperature at 675±75° C. for 11 hours, and then cooling down to room temperature as furnace cooling to form cladding glass tube.
(2) the cladding glass tube is nested with microchannel plate core glass rod resistant to ion bombardment, followed by drawing and forming glass single-fiber and glass multi-fiber, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.; more specifically, in this example, the chemical etchant is nitric acid, the total concentration of the chemical etchant is 30 mol %, the etching time of the chemical etchant is 20 minutes, the etching temperature of the chemical etchant is 35° C.±5° C., FIG. 4 shows the structure of the capillary plate of microchannel plate comprising a cladding glass 7 and a solid-border glass 9.
(4) Subsequently, the capillary plate of microchannel plate is reduced by hydrogen under high temperature and plated with metal electrodes successively to obtain the microchannel plate resistant to ion bombardment. Wherein the temperature for high-temperature hydrogen reduction is from 350° C. to 550° C., the time for the high-temperature hydrogen reduction is from 20 mins to 600 mins, and the flow rate of the hydrogen is from 0.005 L/min to 10 L/min; a emission layer and conductive layer resistant to ion bombardment is generated in situ. More specifically, in this embodiment, the preferred temperature for high-temperature hydrogen reduction is 350° C., the reduction time is 600 min, and the flow rate of hydrogen is 10 L/min; the metal electrode is preferably a surface electrode deposited Ti by electron beam evaporation; the resistance of the metal electrode is not higher than 300Ω. The microchannel plate with solid border resistant to ion bombardment has a channel diameter of 4-20 μm and a thickness of 0.20˜0.80 mm, and an overall diameter Φ=10 mm˜60 mm. More specifically, the microchannel plate with solid border resistant to ion bombardment has a channel diameter of 4 μm and a thickness of 0.20±0.02 mm, and an overall diameter Φ=10 mm. FIG. 5 shows the structure of the above mentioned microchannel plate resistant to ion bombardment comprising microchannel plate substrate 10, inner wall of the channel of microchannel plate 11, electrode 12, wherein, the inner wall of the channel of microchannel plate comprises emission layer and conductive layer resistant to ion bombardment generated in situ 13.

### Example IV (16˜20)

This example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:

### (1) A Cladding Glass Tube is Prepared as Follows

Table 1 shows the composition of glass material for a cladding glass tube to be prepared by the following steps:
1) quartz sand, red lead, bismuth oxide, barium nitrate, barium carbonate, sodium carbonate, cesium carbonate, potassium nitrate, basic magnesium carbonate, calcium carbonate, aluminum hydroxide, and molybdenum compounds are mixed, and clarifying agent As₂O₃ and Sb₂O₃ are added to form a batch; wherein, barium nitrate:barium carbonate=1:1, As₂O₃:Sb₂O₃=2:1;
more specifically, in Example IV, sodium carbonate:cesium carbonate:potassium nitrate=2:9:3, (barium nitrate+barium carbonate):basic magnesium carbonate:calcium carbonate=3:3:2, molybdenum compound in Examples 16-20 is molybdic acid and/or molybdenum trioxide and/or molybdenum dioxide. In Example 16, the molybdenum compound is molybdic acid; in Example 17, the molybdenum compound is the mixture of molybdic acid and molybdenum dioxide(molybdic acid:molybdenum dioxide=1:2); in Example 18, the molybdenum compound is the mixture of molybdenum trioxide and molybdenum dioxide (molybdenum trioxide:molybdenum dioxide=2:1); in Example 19, the compound of molybdenum is the mixture of molybdic acid, molybdenum trioxide and molybdenum dioxide (molybdic acid:molybdenum trioxide:molybdenum dioxide=1:1:1); in Example 20, the molybdenum compound is molybdenum dioxide;
2) the batch containing the clarifying agent evenly mixed is put into a crucible for melting at 1250° C.˜1500° C.;
3) after the melting is completed, the temperature is raised to 1525±25° C. for clarification for 3 hours;
4) then the temperature is reduced to 1250±50° C. for 5 hours to homogenize to form molten glass;
5) the molten glass is drawn from 1150±150° C. until the temperature is lowered to below 700° C. to form a glass tube material;
6) anneal treatment for the formed glass tube material is carried out by holding the temperature at 650±50° C. for 10 hours, and then cooling down to room temperature as furnace cooling to form cladding glass tube.
(2) the glass tube is nested with microchannel plate core glass rod resistant to ion bombardment, followed by drawing and forming glass single-fiber and glass multi-fiber, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.; more specifically, in this example, the chemical etchant is nitric acid, the total concentration of the chemical etchant is 0.2 mol %, the etching time of the chemical etchant is 550 minutes, the etching temperature of the chemical etchant is 85° C.±5° C., FIG. 4 shows the structure of the capillary plate of microchannel plate comprising a cladding glass 7 and a solid-border glass 9.
(4) Subsequently, the capillary plate of microchannel plate is reduced by hydrogen under high temperature and plated metal electrodes successively to obtain the microchannel plate resistant to ion bombardment. Wherein the temperature for high-temperature hydrogen reduction is from 350° C. to 550° C., the time for the high-temperature hydrogen reduction is from 20 mins to 600 mins, and the flow rate of the hydrogen is from 0.005 L/min to 10 L/min; an emission layer and conductive layer resistant to ion bombardment is generated in situ. More specifically, in this embodiment, the preferred temperature for high-temperature hydrogen reduction is 450° C., the reduction time is 420 min, and the flow rate of hydrogen is 0.005 L/min; the metal electrode is preferably a surface electrode deposited Cr by electron beam evaporation; the sheet resistance of the metal electrode is not higher than 300Ω. The microchannel plate with solid border resistant to ion bombardment has a channel diameter of 4-20 μm and a thickness of 0.20˜0.80 mm, and an overall diameter Φ=10 mm˜60 mm. More specifically, the microchannel plate with solid border resistant to ion bombardment has a channel diameter of 20 μm and a thickness of 0.80±0.02 mm, and an overall diameter Φ=60 mm. FIG. 5 shows the structure of the above mentioned microchannel plate resistant to ion bombardment comprising microchannel plate substrate 10, inner wall of the channel of microchannel plate 11, electrode 12, wherein, the inner wall of the channel of microchannel plate comprises emission layer and conductive layer resistant to ion bombardment generated in situ 13.

### Example V (21˜25)

This example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:

### (1) A Cladding Glass Tube is Prepared as Follows

Table 1 shows the composition of glass material for a cladding glass tube to be prepared by the following steps:
1) quartz sand, yellow lead, bismuth oxide, barium nitrate, barium carbonate, sodium carbonate, cesium carbonate, potassium nitrate, basic magnesium carbonate, calcium carbonate, aluminum hydroxide, scandium salt, strontium salt, zirconium compounds and molybdenum compounds are mixed, and clarifying agent As₂O₃ and Sb₂O₃ are added to form a batch; wherein, barium nitrate:barium carbonate=2:1, As₂O₃:Sb₂O₃=2:1;
more specifically, in Example V, sodium carbonate:cesium carbonate:potassium nitrate=1:100:3, (barium nitrate+barium carbonate):basic magnesium carbonate:calcium carbonate=1:1:1, The scandium salt in Examples 21-25 is scandium nitrate and/or scandium carbonate, the strontium salt is strontium nitrate and/or strontium carbonate, the zirconium compounds are zirconium oxide and/or zirconium carbonate and/or zirconium nitrate, and the molybdenum compounds are molybdic acid and/or molybdenum trioxide and/or molybdenum dioxide. In Example 21, the scandium salt is scandium nitrate, the strontium salt is strontium carbonate, the zirconium compound is zirconium oxide, and the molybdenum compound is molybdic acid; in Example 22, the scandium salt is scandium nitrate:scandium carbonate=1:1; the strontium salt is strontium nitrate, the zirconium compound is the mixture of zirconium oxide and zirconium carbonate (zirconium oxide:zirconium carbonate=1:2), and the molybdenum compound is the mixture of molybdenum trioxide and molybdenum dioxide (molybdenum trioxide:molybdenum dioxide=1:1); in Example 23, the scandium salt is scandium nitrate, strontium salt is the mixture of strontium nitrate and strontium carbonate (strontium nitrate:strontium carbonate=1:1), zirconium compound is the mixture of zirconium oxide and zirconium carbonate and zirconium nitrate(zirconium oxide:zirconium carbonate:zirconium nitrate=2:1:1), molybdenum compound is the mixture of molybdic acid, molybdenum trioxide and molybdenum dioxide (molybdic acid:molybdenum trioxide:molybdenum dioxide=1:1:1); In Example 24, the scandium salt is scandium nitrate, the strontium salt is strontium nitrate, the zirconium compound is zirconium oxide, and the molybdenum compound is the mixture of molybdenum trioxide and molybdenum dioxide (molybdenum trioxide:molybdenum dioxide=2:1); in Example 25, the scandium salt is the mixture of scandium nitrate and scandium carbonate (scandium nitrate:scandium carbonate=1:2), the strontium salt is the mixture of strontium nitrate and strontium carbonate (strontium nitrate:strontium carbonate=1:1), the zirconium compound is the mixture of zirconium oxide and zirconium nitrate (zirconium oxide:zirconium nitrate=1:1), and the molybdenum compound is molybdic acid.
2) the batch containing the clarifying agent evenly mixed is put into a crucible for melting at 1300° C.˜1550° C.;
3) after the melting is completed, the temperature is raised to 1575±25° C. for clarification for 9 hours;
4) then the temperature is reduced to 1450±50° C. for 3 hours for homogenization to form molten glass;
5) the molten glass is drawn from 1225±125° C. until the temperature is lowered to below 730° C. to form a glass tube material;
6) anneal treatment for the formed glass tube material is carried out by holding the temperature at 655±55° C. for 6 hours, and then cooling down to room temperature as furnace cooling to form cladding glass tube.
(2) the cladding glass tube is nested with microchannel plate core glass rod resistant to ion bombardment, followed by drawing and forming glass single-fiber and glass multi-fiber, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.; more specifically, in this example, the chemical etchant is nitric acid and hydrochloric acid with the ratio of 1:1, the total concentration of the chemical etchant is 13 mol %, the etching time of the chemical etchant is 100 minutes, the etching temperature of the chemical etchant is 55° C.±5° C., FIG. 4 shows the structure of the capillary plate of microchannel plate comprising a cladding glass 7 and a solid-border glass 9.
(4) Subsequently, the capillary plate of microchannel plate is reduced by hydrogen under high temperature and plated with metal electrodes successively to obtain the microchannel plate resistant to ion bombardment. Wherein the temperature for high-temperature hydrogen reduction is from 350° C. to 550° C., the time for the high-temperature hydrogen reduction is from 20 mins to 600 mins, and the flow rate of the hydrogen is from 0.005 L/min to 10 L/min; an emission layer and conductive layer resistant to ion bombardment is generated in situ. More specifically, in this embodiment, the preferred temperature for high-temperature hydrogen reduction is 510° C., the reduction time is 320 min, and the flow rate of hydrogen is 1.1 L/min; the metal electrode is preferably a surface electrode deposited Ag by electron beam evaporation; the sheet resistance of the metal electrode is not higher than 300Ω. The resultant microchannel plate has a channel diameter of 4-20 μm and a thickness of 0.20˜0.80 mm, and the edge of the microchannel plate resistant to ion bombardment is covered with object with overall diameter Φ=10 mm˜60 mm. More specifically, the obtained microchannel plate has a channel diameter of 8 μm, a thickness of 0.38±0.02 mm and the edge of the microchannel plate resistant to ion bombardment is covered with object with overall diameter Φ=25 mm. FIG. 5 shows the structure of the above mentioned microchannel plate resistant to ion bombardment comprising microchannel plate substrate 10, inner wall of the channel of microchannel plate 11, electrode 12, wherein, the inner wall of the channel of microchannel plate comprises emission layer and conductive layer resistant to ion bombardment generated in situ 13.

### Comparative Example 1 and Comparative Example 2

This comparative example provides a microchannel plate resistant to ion bombardment, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate resistant to ion bombardment comprises the following steps:

### (1) A Cladding Glass Tube is Prepared as Follows

Table 1 shows the composition of glass material for a cladding glass tube to be prepared by the following steps:
1) quartz sand, red lead, bismuth oxide, barium nitrate, sodium carbonate, cesium carbonate, potassium carbonate, basic magnesium carbonate, calcium carbonate, and aluminum hydroxide are mixed, and clarifying agent Sb_{A} is added to form a batch; wherein, in comparative example 1, sodium carbonate:cesium carbonate:potassium carbonate=1:2:1, barium carbonate:basic magnesium carbonate:calcium carbonate=120:70:1; in comparative example 2, sodium carbonate:cesium carbonate: potassium carbonate=1:100:3, barium carbonate:basic magnesium carbonate:calcium carbonate=1:1:1;
2) the batch containing the clarifying agent evenly mixed is put into a crucible for melting at 1100° C.˜1450° C.;
3) after the melting is completed, the temperature is raised to 1500° C. for clarification for 3 hours;
4) then the temperature is cool down to 1200° C. for 1 hour for homogenization to form molten glass;
5) the molten glass is drawn from 1150±50° C. until the temperature is lowered to below 630° C. to form a glass tube material;
6) anneal treatment for the formed glass tube material is carried out by holding the temperature at 600° C. for 8 hours, and then cooling down to room temperature as furnace cooling to form cladding glass tube.
(2) the cladding glass tube is nested with microchannel plate core glass rod resistant to ion bombardment, followed by drawing and forming glass single-fiber and glass multi-fiber, the multi-fibers are stacked regularly, and fused-pressed into a boule. Then the boule in turn is sliced, chamfered, grounded and polished to form a wafer, the structure of which as shown in FIG. 3, comprising a cladding glass 7, a core glass 8, and a solid-border glass 9.
(3) The wafer is corroded by chemical etchant to obtain a capillary plate of microchannel plate, the chemical etchant is the mixture of nitric acid and hydrochloric acid with the ratio of 1:1, the concentration of the chemical etchant is from 25 mol %, the etching time of the chemical etchant is 300 minutes, and the etching temperature of the chemical etchant is 35° C.
(4) Subsequently, the semi-finished microchannel plate is reduced by hydrogen under high temperature and plated metal electrodes successively to obtain cladding microchannel plate resistant to ion bombardment has a channel diameter of 8 μm and a thickness of 0.38 mm, and an overall diameter Φ=25 mm. wherein, the temperature for high-temperature hydrogen reduction is 380° C., the time for the high-temperature hydrogen reduction is from 400 mins, and the flow rate of the hydrogen is 3 L/min; the metal electrode is a Ni—Cr surface electrode; the sheet resistance of the metal electrode is not higher than 300Ω.

### Comparative Example 3

Quartz glass purchased commercially (grade: JGS1)

### Comparative Example 4

This comparative example provides a microchannel plate, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate comprises the following steps:

### (1) A Cladding Glass Tube is Prepared as Follows

Table 1 shows the composition of glass material for preparing the cladding glass tube.
1) quartz sand, red lead, bismuth oxide, barium nitrate, sodium carbonate, cesium carbonate, potassium carbonate, basic magnesium carbonate, calcium carbonate, aluminum hydroxide, zirconium oxide and zirconium carbonate are mixed, and clarifying agent Sb₂O₃, is added to form a batch; wherein, zirconia oxide:zirconium carbonate=1:1, sodium carbonate:cesium carbonate:potassium carbonate=7:5:1, barium nitrate:basic magnesium carbonate:calcium carbonate=1:10:2.
2) the batch containing the clarifying agent evenly mixed is put into a crucible for melting at 1250° C.˜1550° C.;
3) after the melting is completed, the temperature is raised to 1575±25° C. for clarification for 10 hours;
4) then the temperature is reduced to 1475±25° C. for 4 hours for homogenization to form molten glass;
5) the molten glass is drawn from 1225±125° C. until the temperature is lowered to below 730° C. to form a glass tube material;
6) anneal treatment for the formed glass tube material is carried out by holding the temperature at 675±75° C. for 12 hours, and then cooling down to room temperature as furnace cooling.

### Comparative Example 5

This comparative example provides a microchannel plate, comprising a substrate and an electrode arranged on the upper and lower surface of the substrate, wherein the substrate comprises a cladding glass with independent paralleled microchannels and a solid-border glass coated on the outer surface of the cladding glass.

A method for preparing the microchannel plate comprises the following steps:

### (1) A Cladding Glass Tube is Prepared as Follows

Table 1 shows the composition of glass material for preparing the cladding glass tube.
1) quartz sand, red lead, yellow lead, bismuth oxide, barium nitrate, barium carbonate, sodium carbonate, cesium carbonate, potassium carbonate, basic magnesium carbonate, calcium carbonate, aluminum hydroxide, molybdic acid and molybdenum dioxide are mixed, and clarifying agent Sb₂O₃ and As₂O₃ are added to form a batch, wherein, red lead:yellow lead=1:1, molybdic acid:molybdenum dioxide=1:2, Sb₂O₃:As₂O₃=1:1, sodium carbonate:cesium carbonate:potassium carbonate=3:9:2, (barium nitrate+barium carbonate):basic magnesium carbonate:calcium carbonate=3:4:7;
2) the batch containing the clarifying agent evenly mixed is put into a crucible for melting at 1250° C.˜1500° C.;
3) after the melting is completed, the temperature is raised to 1525±25° C. for clarification for 2 hours;
4) then the temperature is cool down to 1250±50° C. for 4.5 hours for homogenization to form molten glass;
5) the molten glass is drawn from 1150±150° C. until the temperature is lowered to below 700° C. to form a glass tube material;
6) anneal treatment for the formed glass tube material is carried out by holding the temperature at 650±50° C. for 10 hours, and then cooling down to room temperature as furnace cooling.

### Experimental Example

The glass materials and microchannel plates obtained in the examples of the present invention and comparative examples is performed performance tests on the thermal expansion coefficient of the glass material, transition temperature, softening temperature, and resistance to crystallization of the glass, specifically including, and the ion bombardment resistance performance of the glass material and the microchannel plate including the ion etching rate of the glass material and the working life of the microchannel plate.

### The Specific Test Method is in the Following:

(1) The thermal expansion coefficient, the transition temperature and the softening temperature of the glass materials are tested based to GB/T 16920-2015;

### (2) Test for Resistance to Argon Ion Bombardment of the Glass:

1) in a vacuum chamber with a vacuum degree better than 1E-6 Pa, the annealed glass material is etched by argon ions with a 5 keV argon ion gun, and the etching time is 30 min;
2) according to ISO4287/1:1984, the etching depth of the glass material etched by argon ions is measured by means of laser confocal microscope in the laser scanning imaging mode, thus calculating the etching rate resistance to argon ions of glass material:etching rate=etching depth/etching time.

### (3) Test for Resistance to Cesium Ion Bombardment of the Glass:

1) in a vacuum chamber with a vacuum degree better than 1E-6 Pa, the annealed glass material is etched by argon ion with a 2.5 keV cesium ion gun, and the etching time is 30 min;
2) according to ISO4287/1:1984, the etching depth of the glass material etched by cesium ions is measured by means of laser confocal microscope in the laser scanning imaging mode, thus calculating the etching rate resistance to cesium ions of glass material: the etching rate=etching depth/etching time.

### (4) Test the Working Life of the Microchannel Plate Resistance to Argon Ion Bombardment:

1) in a vacuum chamber with a vacuum degree better than 1E-6 Pa, the 5 keV argon ion gun is used as the argon ion signal input source, the input surface of the microchannel plate is grounded (0V), and the output surface of the microchannel plate is applied with a −1000V bias voltage, a metal anode is used to collect the output current amplified by the microchannel plate, the metal anode is grounded after it connects in series with a micro-current meter which is used to measure and record the output current of the microchannel plate;
2) the curve of the ion bombardment time versus the output current curve measured is integral to obtain the total extracted charge when the microchannel plate is bombarded by argon ions, which is the working life to resist argon ion bombardment.

### (5) Test the Working Life of the Microchannel Plate Resistance to Cesium Ion Bombardment:

1) in a vacuum chamber with a vacuum degree better than 1E-6 Pa, the 2.5 keV cesium ion gun is used as the argon ion signal input source, the input surface of the microchannel plate is grounded (0V), and the output surface of the microchannel plate is applied with a −1000V bias voltage, a metal anode is used to collect the output current amplified by the microchannel plate, the metal anode is grounded after it connects in series with a micro-current meter which is used to measure and record the output current of the microchannel plate;
2) the curve of the ion bombardment time versus the output current curve measured is integral to obtain the total extracted charge when the microchannel plate is bombarded by cesium ions, which is the working life to resist cesium ion bombardment.

TABLE 1
Glass material composition and thermal performance test results of
the examples and the comparative examples of the present invention

| Component, | | | | | | | | | | |
|---|---|---|---|---|---|---|---|---|---|---|
| mol % | EI | E II | E III | E IV | E V | CE 1 | C E 2 | C E 3 | C E 4 | C E 5 |
| SiO₂ | 75.1 | 68.0 | 60.5 | 64.9 | 65.1 | 72.0 | 64.0 | 100.0 | 60.0 | 66.5 |
| Bi₂O₃ | 1.0 | 1.1 | 1.9 | 5.4 | 1.3 | 1.0 | 2.0 | 0 | 1.8 | 5.3 |
| PbO | 6.1 | 6.0 | 9.0 | 15.4 | 7.5 | 8.7 | 10.0 | 0 | 8.1 | 8.2 |
| Na₂O + | 6.4 | 9.3 | 17.6 | 5.3 | 10.4 | 9.6 | 17.4 | 0 | 15.7 | 9.2 |
| K₂O + Cs₂O | | | | | | | | | | |
| MgO + | 2.5 | 5.4 | 4.9 | 5.0 | 5.3 | 6.6 | 5.5 | 0 | 4.6 | 4.9 |
| BaO + CaO | | | | | | | | | | |
| Al₂O₃ | 0 | 1.2 | 1.3 | 1.0 | 2.5 | 2.1 | 1.1 | 0 | 1.2 | 1.0 |
| Sc₂O₃ | 8.9 | 0 | 0 | 0 | 1.8 | 0 | 0 | 0 | 0 | 0 |
| SrO | 0 | 9.0 | 0 | 0 | 4.3 | 0 | 0 | 0 | 0 | 0 |
| ZrO₂ | 0 | 0 | 4.8 | 0 | 0.9 | 0 | 0 | 0 | 8.6 | 0 |
| MoO₃ + | 0 | 0 | 0 | 3.0 | 0.9 | 0 | 0 | 0 | 0 | 4.9 |
| MoO₂ | | | | | | | | | | |
| Sum | 100.0 | 100.0 | 100.0 | 100.0 | 100.0 | 100.0 | 100.0 | 100.0 | 100.0 | 100.0 |
| Clarifying | (wt %, weight percentage accounting for the glass batch) | | | | | | | | | |
| agent | | | | | | | | | | |
| Sb₂O₃ and/or | 0.1 | 0.5 | 0.8 | 0.3 | 0.2 | 0.3 | 0.2 | — | 0.2 | 0.1 |
| As₂O₃ | | | | | | | | | | |
| Test items | test results of thermal performance | | | | | | | | | |
| α_{20-300° C.} | 64 | 77 | 95 | 61 | 68 | 71 | 83 | — | — | — |
| (×10⁻⁷/° C.) | | | | | | | | | | |
| T_{g} (° C.) | 545 | 601 | 643 | 621 | 627 | 521 | 541 | — | — | — |
| T_{f} (° C.) | 627 | 677 | 701 | 688 | 707 | 601 | 617 | — | — | — |
| Anti- | Excellent | good | good | good | good | Excellent | Excellent | — | inferior | inferior |
| crystallization | | | | | | | | | | |
| performance | | | | | | | | | | |

E in the above table means example, for example, EI means Example I; CE in the above table means comparative example, for example, CE1 means Comparative Example 1.

Comparative Example 3, quartz glass purchased commercially, is only used as the reference glass in the ion etching rate test, and can be directly excluded as a cladding glass material for microchannel plates, since it cannot be reduced by high-temperature hydrogen to obtain a suitable bulk resistance required for the application of microchannel plates, so it is not necessary and has not been investigated for its thermodynamic properties.

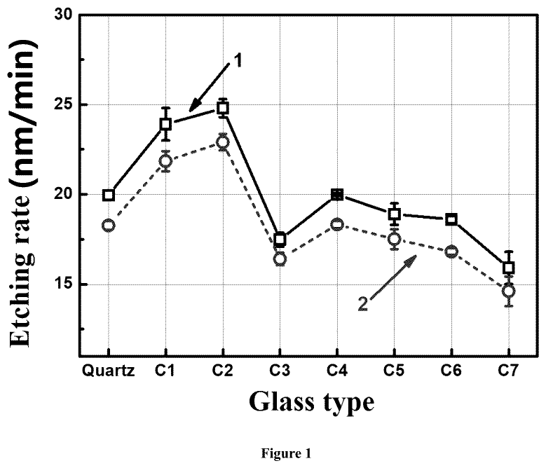

It can be seen from FIG. 1 of the specification that when oxides of Sc₂O₃, SrO, ZrO₂, MoO₃, MoO₂ are not introduced into the glass, as in Comparative Example 1 and Comparative Example 2, the ion etching rate of the glass material will increase significantly, that is, the ion bombardment resistance of the glass material is obviously insufficient, and when oxides of Sc₂O₃, SrO, ZrO₂, MoO₃, MoO₂ are introduced into the glass, the ion etching rate of the glass material will be significantly reduced, that is, the ion bombardment resistance of the glass material will be significantly improved. While it can be seen from Table 1 that when oxides of Sc₂O₃, SrO, ZrO₂, MoO₃, MoO₂ are introduced into the glass, the transition temperature and softening temperature of the glass material will increase, in some examples, the anti-crystallization performance will become worse. As shown in the comparative example 4 and comparative example 5 in the table 1, when the content of ZrO₂ exceeds 6 mol % (8.6 mol %), the anti-crystallization performance of the glass is poor, when the content of MoO₃ and MoO₂ exceeds 3 mol % (4.9 mol %), the anti-crystallization performance of the glass is also significantly deteriorated, so the glass materials in Comparative Example 4 and Comparative Example 5 cannot be processed and sampled for thermodynamic performance testing (thermodynamic expansion, transition temperature, softening temperature). Therefore, it is necessary to comprehensively consider the bombardment resistance characteristics of the glass material, the thermodynamic properties of the glass, and the glass forming characteristics, etc., so as to obtain the cladding glass with excellent ion bombardment resistance and suitable for the production of the microchannel plate.

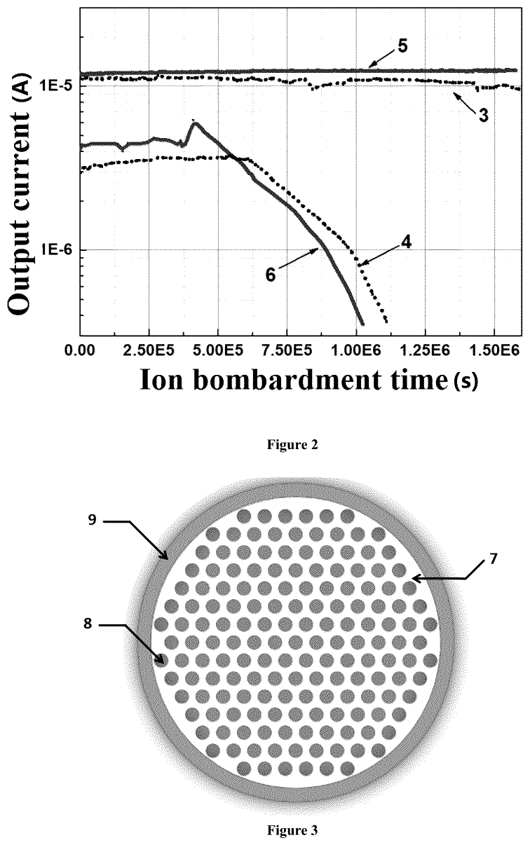

It can be seen from FIG. 2 of the specification that the argon ion-resistant working life (total extracted charge) of the microchannel plate using the ion bombardment resistant glass material of Example 1 as cladding glass exceeds 17 C, and the cesium ion-resistant working life (total extracted charge) is more than 19 C, and comparative example 1 (conventional microchannel plate that is not resistant to ion bombardment) has an argon ion bombardment resistant working life (total extracted charge) less than 3 C, and a cesium ion bombardment resistant working life (total extracted charge) less than 3.5 C, that is, the ion bombardment resistant working life of the microchannel plate using glass material resistant to ion bombardment as cladding glass is greatly improved.

Apparently, the above-described embodiments are merely examples for the purpose of clarity and are not intended to limit the embodiments. For one of ordinary skill in the art, other different forms of changes or variations can be made on the basis of the above description. It is unnecessary and impossible to be exhaustive of all embodiments. Obvious changes or modifications extended therefrom are still within the protection scope of the invention.

1. A glass composition resistant to ion bombardment, in terms of mole percentage, comprising:
60 mole % to 78 mole % of SiO₂;
1 mole % to 6 mole % of Bi₂O₃;
5 mole % to 18 mole % of PbO;
5 mole % to 20 mole % of alkali metal oxide;
2 mole % to 8 mole % of alkaline-earth metal oxide;
0.1 mole % to 2.5 mole % of Al₂O₃; and
3 mole % to 9 mole % of specialty oxide;
wherein, the specialty oxide is selected from at least one of Sc₂O₃, SrO, ZrO₂, MoO₃ and MoO₂, and
0 mole % to 9 mole % of Sc₂O₃;
0 mole % to 9 mole % of SrO;
0 mole % to 6 mole % of ZrO₂; and
0 mole % to 3 mole % of MoO₃ and/or MoO₂.

2. The glass composition resistant to ion bombardment according to claim 1, wherein, based on the total mass of the components in claim 1, the glass composition further comprises a clarifying agent accounting for 0.1% to 0.8% of the total mass of the components.

3. The glass composition resistant to ion bombardment according to claim 1 or 2, wherein, the alkali metal oxide is selected from at least one of Na₂O, K₂O and Cs₂O;
the alkaline earth metal oxide is selected from at least one of MgO, BaO and CaO; and
the clarifying agent is Sb₂O₃ and/or As₂O₃.

4. A cladding glass of microchannel plate resistant to ion bombardment, wherein, the cladding glass of microchannel plate has the same constitution as that of the glass composition of any one of claims 1-3.

5. A method for preparing the cladding glass of microchannel plate resistant to ion bombardment of claim 4, comprising the following steps:
proportioning components, and mixing uniformly, followed by melting, clarifying, homogenizing, drawing and forming, and annealing to obtain the cladding glass of microchannel plate resistant to ion bombardment.

6. The method for preparing the cladding glass of microchannel plate resistant to ion bombardment according to claim 5, wherein the temperature of the melting is from 1250° C. to 1550° C.;
optionally, the melting is performed under a weak oxidizing atmosphere, and an oxygen partial pressure in the weak oxidizing atmosphere is from 25 kPa to 100 kPa;
in the clarifying step, the temperature is from 1400° C. to 1600° C., and the time is from 2 hours to 12 hours;
in the homogenizing step, the temperature is from 1200° C. to 1500° C., and the time is from 1 hours to 5 hours;
the initial temperature of the drawing process is 1000˜1350° C., until the temperature is lowered to below 600° C.˜750° C. to form a glass tube material;
in the annealing step, the holding temperature is from 550° C. to 750° C., the holding time is from 2 hours to 12 hours, and then the temperature is lowered to room temperature as furnace cooling.

7. A microchannel plate resistant to ion bombardment, comprising,
a substrate; and
an electrode arranged on the upper and lower surface of the substrate;
wherein the substrate comprises a cladding glass with independent paralleled microchannels and a solid-border glass coated on the outer surface of the cladding glass, the cladding glass is the cladding glass of microchannel plate of claim 4 or the cladding glass of microchannel plate prepared by the method of claims 5 or 6.

8. A method for preparing the microchannel plate resistant to ion bombardment of claim 7, comprising the following steps:
S1. drawing and forming a cladding glass tube;
S2. preparing a core material glass rod;
S3. nesting the core material glass rod into the cladding glass tube and drawing into a single-fiber;
S4. packing several single-fibers for drawing into a multi-fibers;
S5. stacking the multi-fibers regularly, and fusing to form a boule;
S6. slicing, chamfering, grounding and polishing the boule to obtain a wafer;
S7. etching the wafer by chemical etchant to remove a soluble core glass, followed by hydrogen reduction and vacuum deposition of metal electrodes, thus obtaining the microchannel plate resistant to ion bombardment.

9. The method for preparing the microchannel plate resistant to ion bombardment according to claim 8, wherein the step S7 specifically comprises:
etching the wafer by chemical etchant to remove a soluble core glass to prepare independent paralleled microchannels structure with millions of micron-level pores;
reducing the independent paralleled microchannels structure by high-temperature hydrogen to form a conductive layer resistant to ion bombardment and a secondary electron emission layer resistant to ion bombardment growing in situ on the inner wall surface of the independent paralleled microchannels; and then, vapor-depositing metal electrodes on the upper and lower surfaces of a reduced plate to obtain the microchannel plate resistant to ion bombardment.

10. The method for preparing the microchannel plate resistant to ion bombardment according to claim 8 or 9, wherein, in step S1, the temperature for drawing and forming the cladding glass tube is from 1000° C. to 1350° C.;
in step S7, the chemical etchant is at least one of nitric acid and hydrochloric acid, the concentration of the chemical etchant is from 0.1 mol % to 30 mol %, the etching time of the chemical etchant is from 10 minutes to 600 minutes, and the etching temperature of the chemical etchant is from 30° C. to 90° C.;
in step S7, the temperature for the hot hydrogen reduction is from 350° C. to 550° C., the time for the hot hydrogen reduction is from 20 mins to 600 mins, and the flow rate of the hydrogen is from 0.005 L/min to 10 L/min;
in step S7, the metal electrode is Ti, or Cr, or Au, or Ag, or Ni/Cr surface electrode; the sheet resistance of the metal electrode is not higher than 300Ω.
